(19) United States
(12) Patent Application Publication
(10) Pub. No.: US 2013/0099984 A1
(43) Pub. Date: Apr. 25, 2013

(54) ANTENNA COMBINED WITH TERMINAL HOUSING

(71) Applicant: ACE TECHNOLOGIES CORPORATION, Incheon-si (KR)

(72) Inventor: Jong-Ho Jung, Gyeonggi-do (KR)

(73) Assignee: ACE TECHNOLOGIES CORPORATION, Incheon-si (KR)

(21) Appl. No.: 13/659,599

(22) Filed: Oct. 24, 2012

(30) Foreign Application Priority Data
Oct. 25, 2011 (KR) 10-2011-0109419

(51) Int. Cl. H01Q 1/50; H01Q 1/24

(52) U.S. Cl. 343/702

(57) ABSTRACT

An antenna combined with a terminal housing is disclosed. The disclosed antenna includes an outer frame radiator, which is joined to a side wall of the terminal housing, and an inner frame radiator, which has one end joined to a first point on the outer frame radiator and the other end joined to a second point on the outer frame radiator, and which forms a loop by joining the outer frame radiator, where a feed signal is provided to the inner frame radiator. The disclosed antenna provides the advantages of preventing property changes caused by contact between a person's body and the terminal, and of minimizing mounting space while maintaining stable characteristics.

### TECHNICAL FIELD

Embodiments of the present invention relate to an antenna for transmitting and receiving signals, more particularly to an antenna built into a terminal.

### BACKGROUND ART

In current times, it is required of the mobile communication terminal to provide various services from a single terminal, and the functions provided are also becoming more sophisticated.

The current mobile communication terminal, represented by the smart phone, is required to provide more than simple communication functions and is in fact expected to provide the functionalities of a small computer. In addition to this, the current mobile communication terminal is trending towards a slimmer structure.

As the mobile communication terminal is required to provide more functions from a slimmer structure, there is also a need to minimize the space in which to mount the antenna for transmitting and receiving signals. However, due to the demands for wide-band and multi-band characteristics, there is a limit to how much the size of the antenna can be reduced.

While it is typical for an antenna to be attached to a carrier when built into a terminal, an antenna may be used that is joined to the inner wall of the terminal's housing, in order to minimize the antenna mounting space. This type of antenna combined with the housing can reduce the antenna's mounting space compared to existing antennas, but since it is joined to the housing, the properties of the antenna may change when a person's hand or head touches the housing.

### DISCLOSURE

### Technical Problem

An aspect of the present invention provides an antenna combined with a terminal housing that can prevent property changes caused by contact between a person's body and the terminal.

Also, an aspect of the present provides an antenna combined with a terminal housing that can minimize mounting space while maintaining stable characteristics.

### Technical Solution

One aspect of the present invention, devised to achieve the objectives above, provides an antenna combined with a terminal housing that includes: an outer frame radiator, which is joined to a side wall of the terminal housing, and an inner frame radiator, which has one end joined to a first point on the outer frame radiator and the other end joined to a second point on the outer frame radiator, and which forms a loop by joining the outer frame radiator, where a feed signal is provided to the inner frame radiator.

The outer frame radiator may have a ‘C’ shape, comprising a first horizontal frame and a second frame opposite each other and a vertical frame connecting the first horizontal frame and the second horizontal frame.

The inner frame radiator may be joined to a first point on the first horizontal frame and to a second point on the second horizontal frame.

The inner frame radiator may have a ‘C’ shape in an area excluding the joining positions such that the inner frame radiator maintains a particular distance from the outer frame radiator.

The antenna may further include an impedance matching member, of which one end may be joined to a third point on the first horizontal frame and the other end may be joined to a fourth point on the second horizontal frame. The antenna may further include a first impedance matching member, of which one end may be joined to a third point on the first horizontal frame and the other end may be joined to a ground.

The antenna may further include a second impedance matching member, of which one end may be joined to a fourth point on the second horizontal frame and the other end may be joined to a ground.

Another aspect of the present invention provides an antenna combined with a terminal housing that includes: an outer frame radiator, which is joined to a side wall of the terminal housing and which has a ‘C’ shape, and an inner frame radiator, which is joined to the outer frame radiator to form an electrical loop, where a feed signal is provided to the inner frame radiator.

The outer frame radiator may include a first horizontal frame and a second frame opposite each other and a vertical frame connecting the first horizontal frame and the second horizontal frame, and the inner frame radiator may be joined to a first point on the first horizontal frame and to a second point on the second horizontal frame.

The inner frame radiator may have a ‘C’ shape in an area excluding the joining positions such that the inner frame radiator maintains a particular distance from the outer frame radiator.

The antenna may further include an impedance matching member, of which one end may be joined to a third point on the first horizontal frame and the other end may be joined to a fourth point on the second horizontal frame.

The antenna may further include a first impedance matching member, of which one end may be joined to a third point on the first horizontal frame and the other end may be joined to a ground.

The antenna may further include a second impedance matching member, of which one end may be joined to a fourth point on the second horizontal frame and the other end may be joined to a ground.

### Advantageous Effects

Certain embodiments of the present provide the advantages of preventing property changes caused by contact between a person's body and the terminal, and of minimizing mounting space while maintaining stable characteristics.

### DESCRIPTION OF DRAWINGS

FIG. 1 illustrates the structure of an antenna combined with a terminal housing according to an embodiment of the present invention.

FIG. 2 illustrates a loop formed by an inner frame radiator and an outer frame radiator.

FIG. 3 illustrates the structure of an antenna combined with a terminal housing according to another embodiment of the present invention.

FIG. 4 illustrates the structure of an antenna combined with a terminal housing according to yet another embodiment of the present invention.

FIG. 5 illustrates an example of a feeding unit for an antenna combined with a terminal housing according to an embodiment of the present invention.

FIG. 6 is a graph comparing efficiency between cases in which there is a hand effect applied and in which there is no hand effect applied (free space), for a typical frame antenna that is not equipped with an inner frame radiator.

FIG. 7 is a graph comparing efficiency between cases in which there is a hand effect applied and in which there is no hand effect applied (free space), for an antenna equipped with an inner frame radiator according to an embodiment of the present invention.

### MODE FOR INVENTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the written description, certain detailed explanations of related art are omitted when it is deemed that they may unnecessarily obscure the essence of the present invention. In describing the drawings, similar reference numerals are used for similar elements.

Certain embodiments of the present invention will be described below in more detail with reference to the accompanying drawings.

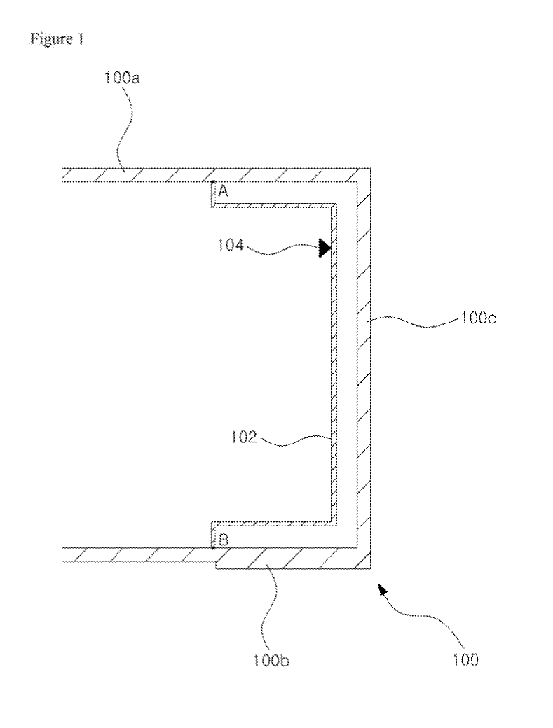

FIG. 1 illustrates the structure of an antenna combined with a terminal housing according to an embodiment of the present invention.

Referring to FIG. 1, an antenna according to an embodiment of the present invention may include an outer frame radiator 100, an inner frame radiator 102, and a feeding point 104.

The outer frame radiator 100 may be joined to the housing of the terminal and may be made of a conductive material. For example, it may be made of a conductive material such as copper and may take the form of a thin conductive wire.

The outer frame radiator 100 may be joined to an inner wall of the terminal housing. As the terminal housing has a quadrilateral form, the outer frame radiator 100 may be shaped as a ‘C’. The form of the outer frame radiator may vary according to the form of the terminal housing, and if the terminal housing does not have a quadrilateral form, the outer frame radiator 100 can also assume a different form.

The outer frame radiator 100 shaped as a ‘C’ may be divided into two horizontal frames 100a, 100b opposite each other and one vertical frame 100c.

The inner frame radiator 102 may be joined to a first point A and a second point B on the outer frame radiator. The inner frame radiator 102 can also be made of a conductive material, such as copper, for example.

The inner frame radiator 102 may connect the first point A and the second point B. The inner frame radiator 102 and the outer frame radiator 100 can be made in an integrated form, or the inner frame radiator 102 can be joined to the outer frame radiator 100 after the outer frame radiator 100 is joined to the terminal housing.

Unlike the outer frame radiator 100, the inner frame radiator 102 may not be joined to a side wall of the housing. The inner frame radiator 102 can be joined to the upper wall or the lower wall of the housing, or can be positioned in an empty area inside without being joined to a wall of the housing.

According to an embodiment of the present invention, it may be preferable to set the first point A as a point on the first horizontal frame 100a of the outer frame radiator 100 and to set the second point B as a point on the second horizontal frame 100b.

The inner frame radiator 102 may maintain a certain distance from the outer frame radiator 100 at points other than the joining positions. In order to maintain a particular distance, the inner frame radiator 102 can also have a ‘C’ shape, but the invention is not thus limited.

The inner frame radiator 102 and the outer frame radiator 100 may form a loop L.

Feeding may be performed for the inner frame radiator 102, and the outer frame radiator 100 may not be electromagnetically joined with the feeding point. A variety of feeding methods can be applied to the inner frame radiator 102, such as by using a coaxial cable, a strip line, a CPW, coupling, etc.

An antenna that is joined to a side wall of the housing, similar to the antenna according to an embodiment of the present invention, can be more susceptible to the hand effect, which describes changes in properties that may occur when the terminal is held in a hand, compared to typical internal antennas. The inner frame radiator 102 in an embodiment of the present invention, however, makes it possible to minimize property changes caused by the hand effect.

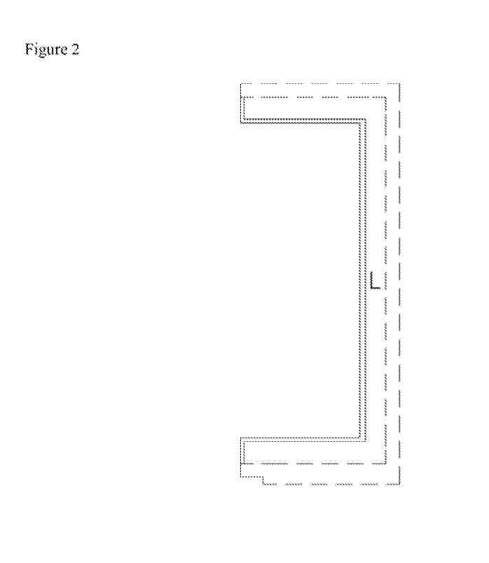

FIG. 2 illustrates a loop formed by the inner frame radiator and the outer frame radiator. Users generally hold the bottom of the terminal when taking a call, and the portion affected by the hand effect is depicted in dotted lines in FIG. 2.

A conventional antenna of the type that is combined with the housing may include only the outer frame radiator, and may be greatly influenced by the hand effect when a user holds the terminal in the user's hand, resulting in degraded call quality. The inner frame radiator of the present invention, however, may serve to suppress the property changes caused by the hand effect.

In the antenna according to an embodiment of the present invention in which an inner frame radiator 102 is joined to the outer frame radiator 100, a small amount of current may flow in the portion of the loop depicted in dotted lines in FIG. 2, while a relatively larger amount of current, compared to the portion of the outer frame radiator 100 depicted in dotted lines, may flow in the inner frame radiator 102 depicted in solid lines, since feeding is performed directly to the inner frame radiator 102. The reason why there is a relatively larger amount of current flowing in the inner frame radiator 102 is because the feeding point is formed on the inner frame radiator 102.

That is, in the loop L composed of the inner frame radiator 102 and the outer frame radiator 100, a relatively larger current may flow in the inner frame radiator 102, and a relatively smaller current may flow in the outer frame radiator 100. Consequently, the portion of the outer frame radiator 100 depicted in dotted lines may be less affected by the hand effect, which occurs when a user holds the terminal in the user's hand, and the property changes of the antenna may be reduced, compared to the case of forming the radiator only with the outer frame radiator 100.

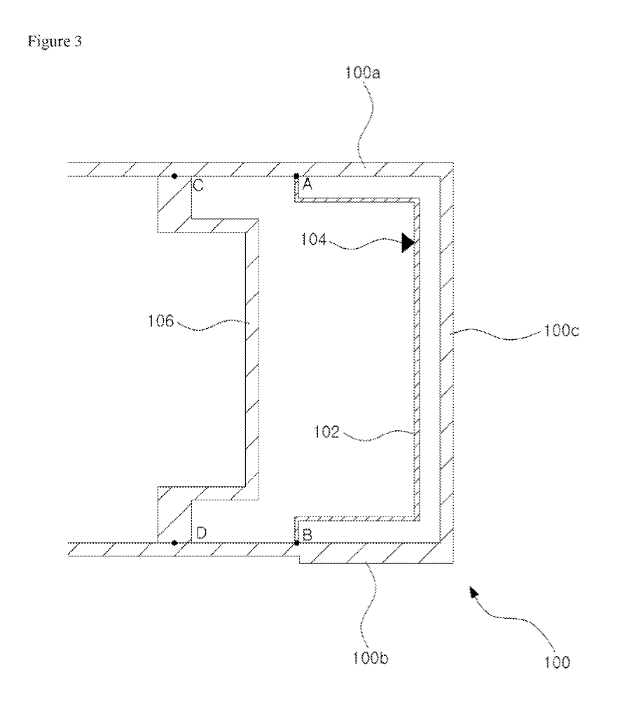

FIG. 3 illustrates the structure of an antenna combined with a terminal housing according to another embodiment of the present invention.

Referring to FIG. 3, an antenna according to another embodiment of the present invention may include an outer frame radiator 100, an inner frame radiator 102, a feeding point 104, and an impedance matching member 106.

Compared to the antenna illustrated in FIG. 1, the antenna illustrated in FIG. 3 additionally includes the impedance matching member 106, but the other components and their functions are the same as those of the antenna illustrated in FIG. 1.

According to an embodiment of the present invention, the impedance matching member 106 may be structured to have one end connected with a third point C on the first horizontal frame 100a and the other end connected to a fourth point D on the second horizontal frame 100b.

The third point C and the fourth point D may be positioned further away from the vertical frame 100c of the outer frame radiator 100, compared to the first point A and the second point B.

The impedance matching member 106 can be joined to the upper wall or the lower wall of the terminal housing, or can be arranged in an empty space inside the terminal housing without being joined to the housing.

The position and length of the impedance matching member can be determined according to the frequency for which impedance matching is required.

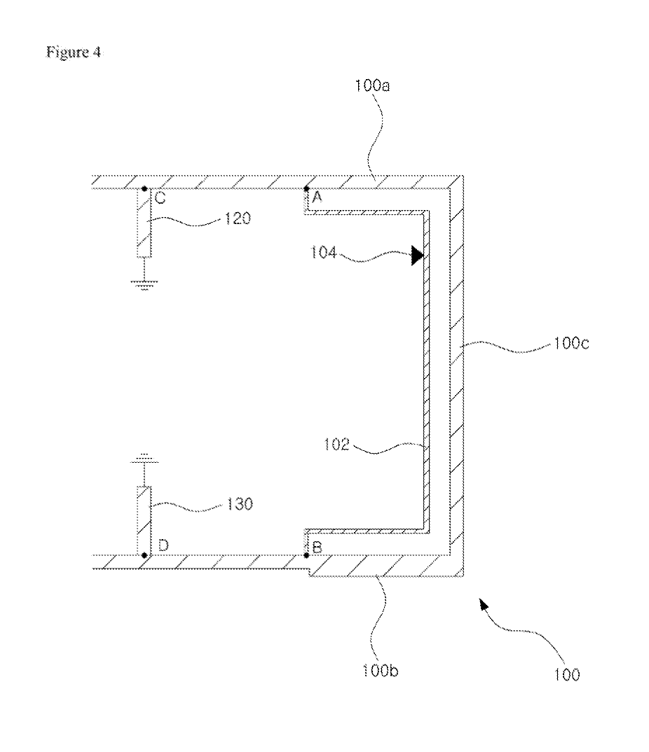

FIG. 4 illustrates the structure of an antenna combined with a terminal housing according to yet another embodiment of the present invention.

Referring to FIG. 4, an antenna according to yet another embodiment of the present invention may include an outer frame radiator 100, an inner frame radiator 102, a feeding point 104, and impedance matching members 120, 130.

The antenna illustrated in FIG. 4 differs from the antenna illustrated in FIG. 3 in the forms of the impedance matching members 120, 130. The antenna illustrated in FIG. 4 may include two impedance matching members 120, 130, with a first matching member 120 having one end joined with a third point C on the first horizontal frame 100a of the outer frame radiator 100 and the other end joined with a ground. Here, the ground can be a ground formed on a PCB of the terminal.

The second matching member may have one end joined with a fourth point D on the second horizontal frame 100b of the outer frame radiator and the other end joined with a ground.

As in the third embodiment, the third point C and the fourth point D may be positioned further away from the vertical frame 100c of the outer frame radiator 100, compared to the first point A and the second point B.

Although FIG. 4 illustrates two impedance matching members 120, 130, it would be apparent to those skilled in the art that the number of impedance matching members 120, 130 joined with the outer frame radiator and with the ground can be modified as needed.

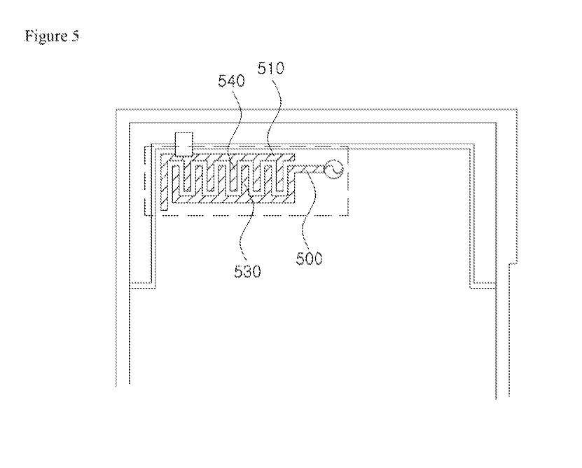

FIG. 5 illustrates an example of a feeding unit for an antenna combined with a terminal housing according to an embodiment of the present invention.

Referring to FIG. 5, a feeding unit that provides feeding to the inner frame radiator 102 can include a first conductive member 500 and a second conductive member 510.

The first conductive member 500 and the second conductive member 510 may be separated by a particular distance, with a power feed supplied to the first conductive member 500, and coupling feed performed from the first conductive member 500 to the second conductive member 510.

The second conductive member 510 may be joined to the inner frame radiator 102 to provide feed signals.

Referring to FIG. 5, a multiple number of protrusions 530, 540 can be formed between the first conductive member 500 and second conductive member 510, protruding from the first conductive member 500 and second conductive member 510.

The coupling feed structure illustrated in FIG. 5 may be a feed structure for distributed matching, and the sufficient lengths of the first conductive member 500 and second conductive member 510 can create progressive waves, to provide impedance matching for a wide band.

The protrusions 530, 540 protruding from the first conductive member 500 and second conductive member 510 serve to substantially increase the electrical lengths of the first conductive member 500 and second conductive member 510.

The protrusions 530, 540 protruding periodically from the first conductive member 500 and second conductive member 510 may enable a type of delayed wave structure, to increase the electrical lengths of the first conductive member 500 and second conductive member 510.

As described above, a variety of feeding methods can be applied to the inner frame radiator 102, and the feeding structure illustrated in FIG. 5 merely provides one such example.

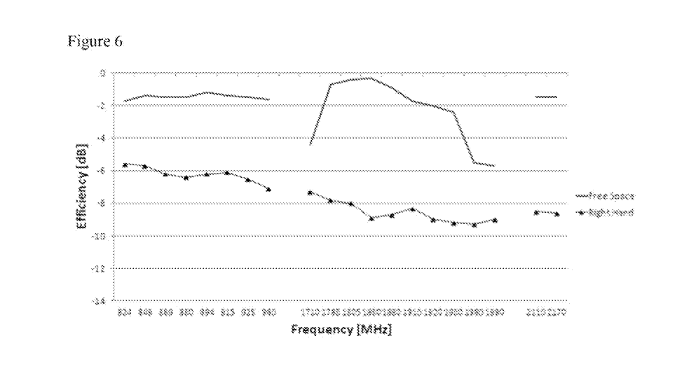

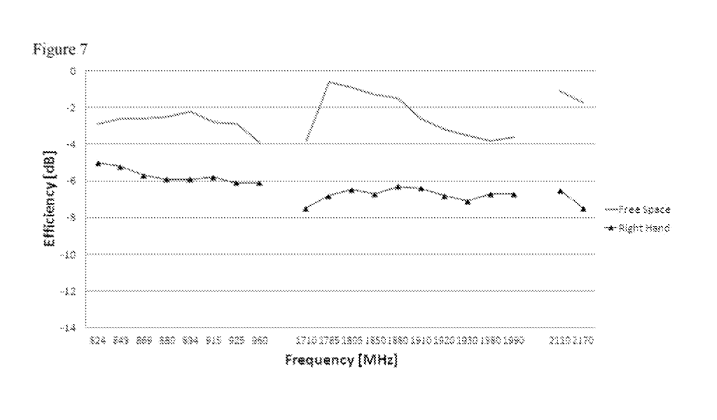

FIG. 6 is a graph comparing efficiency between cases in which there is a hand effect applied and in which there is no hand effect applied (free space) for a typical frame antenna that is not equipped with an inner frame radiator, while FIG. 7 is a graph comparing efficiency between cases in which there is a hand effect applied and in which there is no hand effect applied (free space) for an antenna equipped with an inner frame radiator according to an embodiment of the present invention.

Referring to FIG. 6, it can be seen that, for the case in which there is no inner frame radiator included, the hand effect may result in large property changes in the low band and the high band, with significant property changes particularly in the high band.

However, referring to FIG. 7, it can be seen that, for the case in which an inner frame radiator is included, there may still be reduced efficiency, but the property changes may be reduced compared to FIG. 6.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

1. An antenna combined with a terminal housing, the antenna comprising:
an outer frame radiator joined to a side wall of the terminal housing; and
an inner frame radiator having one end thereof joined to a first point on the outer frame radiator and having the other end thereof joined to a second point on the outer frame radiator, the inner frame radiator forming a loop by joining the outer frame radiator,
wherein a feed signal is provided to the inner frame radiator.

2. The antenna combined with a terminal housing according to claim 1, wherein the outer frame radiator has a ‘C’ shape, comprising a first horizontal frame and a second frame opposite each other and a vertical frame connecting the first horizontal frame and the second horizontal frame.

3. The antenna combined with a terminal housing according to claim 2, wherein the inner frame radiator is joined to a first point on the first horizontal frame and to a second point on the second horizontal frame.

4. The antenna combined with a terminal housing according to claim 3, wherein the inner frame radiator has a ‘C’ shape in an area excluding the joining positions such that the inner frame radiator maintains a particular distance from the outer frame radiator.

5. The antenna combined with a terminal housing according to claim 3, further comprising an impedance matching member, the impedance matching member having one end thereof joined to a third point on the first horizontal frame and having the other end thereof joined to a fourth point on the second horizontal frame.

6. The antenna combined with a terminal housing according to claim 3, further comprising a first impedance matching member, the first impedance matching member having one end thereof joined to a third point on the first horizontal frame and having the other end thereof joined to a ground.

7. The antenna combined with a terminal housing according to claim 6, further comprising a second impedance matching member, the second impedance matching member having one end thereof joined to a fourth point on the second horizontal frame and having the other end thereof joined to a ground.

8. An antenna combined with a terminal housing, the antenna comprising:
an outer frame radiator joined to a side wall of the terminal housing and having a ‘C’ shape; and
an inner frame radiator joined to the outer frame radiator to form an electrical loop,
wherein a feed signal is provided to the inner frame radiator.

9. The antenna combined with a terminal housing according to claim 8, wherein the outer frame radiator comprises a first horizontal frame and a second frame opposite each other and a vertical frame connecting the first horizontal frame and the second horizontal frame, and the inner frame radiator is joined to a first point on the first horizontal frame and to a second point on the second horizontal frame.

10. The antenna combined with a terminal housing according to claim 9, wherein the inner frame radiator has a ‘C’ shape in an area excluding the joining positions such that the inner frame radiator maintains a particular distance from the outer frame radiator.

11. The antenna combined with a terminal housing according to claim 9, further comprising an impedance matching member, the impedance matching member having one end thereof joined to a third point on the first horizontal frame and having the other end thereof joined to a fourth point on the second horizontal frame.

12. The antenna combined with a terminal housing according to claim 9, further comprising a first impedance matching member, the first impedance matching member having one end thereof joined to a third point on the first horizontal frame and having the other end thereof joined to a ground.

13. The antenna combined with a terminal housing according to claim 12, further comprising a second impedance matching member, the second impedance matching member having one end thereof joined to a fourth point on the second horizontal frame and having the other end thereof joined to a ground.
